(19) United States
(12) Patent Application Publication
(10) Pub. No.: US 2024/0188198 A1
(43) Pub. Date: Jun. 6, 2024

(54) INDUCTION ENERGY TRANSMISSION SYSTEM

(71) Applicant: BSH Hausgeräte GmbH, Munich (DE)

(72) Inventors: Javier Lasobras Bernad, EJEA DE LOS CABALLEROS (ZARAGOZA) (ES); Sergio Llorente Gil, Zaragoza (ES); Jesus Manuel Moya Nogues, Zaragoza (ES); Jorge Pascual Aza, Zaragoza (ES); Javier Serrano Trullen, Zaragoza (ES); Jorge Tesa Betes, Zaragoza (ES)

(21) Appl. No.: 18/285,660

(22) PCT Filed: Apr. 6, 2022
(86) PCT No.: PCT/EP2022/059056

§ 371 Date: Oct. 5, 2023

(30) Foreign Application Priority Data
Apr. 19, 2021 (EP) 21382332.1

(51) Int. Cl. H05B 6/12

(52) U.S. Cl. CPC H05B 6/1236

(57) ABSTRACT

An induction energy transmission system includes a supply unit including a supply induction element designed to inductively provide energy and an inverter unit designed to operate the supply induction element, a small household appliance including a receiving induction element designed to receive inductively provided energy, and a control unit designed to control the inverter unit. The control unit is designed such that in at least one operating state for adjusting a supply power for the small household appliance a provision of supply AC current by the inverter unit for a first time window within a control period is interrupted and in a second time window within the control period at least one switching parameter of a switching parameter set of the inverter unit is adapted.

The invention relates to an induction energy transmission system according to the preamble of claim 1 and a method for operating an induction energy transmission system according to the preamble of claim 14.

Induction energy transmission systems are already known from the prior art for the inductive transmission of energy from a primary coil of a supply unit to a secondary coil of a small household appliance. For example, the publication U.S. Pat. No. 3,761,668 A proposes an induction cooktop which in addition to inductively heating cookware is also provided so as to supply energy to small household appliances, for example a mixer. In this case, energy that is inductively provided by a primary coil of the induction cooktop is in part transmitted to a secondary coil that is integrated in the small household appliance.

In view of the very large number of different commercially available small household appliances which can be supplied inductively with energy and have in part very different performance requirements, the hitherto known induction energy transmission systems face the problem of having to render it possible to control individually and as required the inductively provided energy. In the case of known solutions in the prior art, it has hitherto not been possible to achieve a continuous inductive energy supply over an entire performance spectrum and flexibility for users with respect to using different small household appliances with different performance requirements is disadvantageously greatly limited.

The object of the invention is in particular, but not limited thereto, to provide a generic system that has improved properties with respect to flexibility. The object is achieved according to the invention by the features of claims 1 and 14, while advantageous embodiments and developments of the invention are apparent in the subordinate claims.

The invention relates to an induction energy transmission system, in particular an induction cooking system, having a supply unit which has at least one supply induction element for inductively providing energy and at least one inverter unit for operating the supply induction element, having at least one small household appliance which has at least one receiving induction element for receiving inductively provided energy, and having a control unit for controlling the inverter unit.

It is proposed that the control unit in at least one operating state so as to adjust a supply power for the small household appliance interrupts a provision of supply AC current by the inverter unit for at least one first time window within a control period and in a second time window within the control period adapts at least one switching parameter of a switching parameter set of the inverter unit.

Such an embodiment renders it possible to provide an induction energy transmission system that has advantageous properties with respect to flexibility. It can be advantageously rendered possible to adjust the supply power in a particularly precise manner over a particularly large power spectrum, so that it is rendered possible to supply inductive energy to a large number of different small household appliances that have different requirements with regard to supply power. In addition, it is advantageously possible to increase efficiency in the case of inductive energy transmission. In particular in the case of low supply powers, it is possible to advantageously reduce energy losses. In addition, particularly uniform and delicate transitions between different power levels of the small household appliance are possible if the control unit in at least one operating state so as to adjust a supply power for the small household appliance in a second time window within the control period adapts at least one switching parameter of a switching parameter set of the inverter unit. Moreover, it is advantageously possible to provide an induction energy transmission system that has improved properties with respect to electromagnetic compatibility.

The induction energy transmission system has at least one main functionality in the form of wireless energy transmission, in particular in a wireless energy supply of small household appliances. In one advantageous embodiment, the induction energy transmission system is configured as an induction cooking system having at least one further main function that is different from a purely cooking function, said main function being in particular at least an energy supply and an operation of the small household appliance. For example, the induction energy transmission system can be configured as an induction baking oven system and/or as an induction grilling system. In particular, the supply unit can be configured as part of an induction backing oven and/or as part of an induction grill. It is preferred that the induction energy transmission system is configured as an induction cooktop system. The supply unit is then in particular configured as part of an induction cooktop. In a further advantageous embodiment, the induction energy transmission system is configured as a kitchen energy supply system and in addition to a main function in the form of an energy supply and operation of small household appliances can be additionally provided so as to provide cooking functions.

A “supply unit” is to be understood in particular as a unit which in at least one operating state provides inductive energy and which has in particular a main functionality in the form of energy provision. In order to provide energy, the supply unit has at least one supply induction element, which has in particular at least one coil, in particular at least one primary coil, and/or is configured as a coil, and which in particular in the operating state provides inductive energy. The supply unit could have at least two, in particular at least three, advantageously at least four, particularly advantageously at least five, preferably at least eight and particularly preferably multiple supply induction elements which in the operating state could each provide inductive energy and especially in particular to a single receiving induction element or to at least two or more receiving induction elements of at least one small household appliance and/or of at least a further small household appliance. At least some of the supply induction elements could be arranged in a close range with respect to each other, for example they could be arranged in a row and/or in the form of a matrix.

The supply unit has at least one inverter unit for operating at least one supply induction element. It is preferred that the inverter unit in the operating state performs a frequency conversion and converts in particular an input-side low frequency AC voltage, in particular a mains AC voltage of a power supply network, into an output-side high frequency AC voltage. It is preferred that the low frequency AC voltage has a frequency of a maximum 100 Hz. It is preferred that the high frequency AC voltage has a frequency of at least 1000 Hz. The inverter unit is connected to the control unit and can be controlled by the control unit by means of control signals. It is preferred that the inverter unit is provided so as by adjusting the high frequency AC voltage to adjust the energy that is inductively provided by the at least one supply induction element. It is preferred that the supply unit comprises at least one rectifier. The rectifier is provided so as to rectify the input-side low frequency AC voltage, in particular the mains AC voltage of a power supply network, in particular into a rectified mains AC voltage. The inverter unit has at least one inverter switching element. It is preferred that, so as to operate the at least one supply induction element, the inverter switching element generates an oscillating electrical AC current, preferably at a frequency of at least 15 kHz, in particular of at least 17 HZ and advantageously of at least 20 kHz. It is preferred that the inverter unit comprises at least two inverter switching elements which are preferably configured as bipolar transistors having an insulated gate electrode. It is preferred that the inverter unit comprises at least one damping capacitor. It is preferred that the frequency of the oscillating electrical AC current that is generated by the inverter switching element in the operating state corresponds at least significantly, preferably precisely, to a switching frequency of the inverter switching element.

It is preferred that the induction energy transmission system has a placement plate onto which at least one small household appliance is placed. A “placement plate” is to be understood as at least one, in particular plate-shaped, unit onto which at least one small household appliance and/or item of cookware is placed and/or at least one item of food to be cooked is laid. The placement plate could be configured for example as a worktop, in particular as a kitchen worktop, or as a part region of at least one worktop, in particular of at least one kitchen worktop, in particular of the induction energy transmission system. Alternatively or additionally, the placement plate could be configured as a cooktop plate. The placement plate that is configured as a cooktop plate could form in particular at least a part of a cooktop outer housing and in particular together with at least an outer housing unit, to which the placement plate that is configured as a cooktop plate could be connected in at least an assembled state, could form the cooktop outer housing at least to a great extent. It is preferred that the placement plate is produced from a non-metal material. The placement plate could be made, for example, at least to a great extent from glass and/or from glass ceramics and/or from Neolith and/or from Dekton and/or from wood and/or from marble and/or from stone, in particular from a natural stone, and/or from a coating material and/or from plastic and/or from ceramics. In the present application, the positional descriptions, such as for example “below” or “above” relate to an assembled state of the placement plate insofar as not otherwise explicitly described. The supply unit is preferably arranged below the placement plate.

The small household appliance is preferably a location-bound household appliance which has at least the receiving induction element and at least one function unit which in an operating state has at least one household appliance function. “Location-bound” is to be understood in this context to mean that the small household appliance can be freely positioned in a household by a user, and in particular without aids, in particular in contrast to a large household appliance which is fixedly positioned and/or installed in a specific position in a household, such as for example a baking oven or a refrigerator. It is preferred that the small household appliance is configured as a small kitchen appliance and in the operating state provides at least one household appliance function for processing foodstuffs. The small household appliance could be configured, but without being limited thereto, for example, as a multifunction kitchen machine and/or as a mixer and/or as a stirrer and/or as a mill and/or as kitchen scales or as a kettle or as a coffee machine or as a rice cooker or as a milk-frother or as a fryer or as a toaster or as a juice extractor or as a cutting machine or the like.

The receiving induction element comprises at least one secondary coil and/or is configured as a secondary coil. In an operating state of the small household appliance, the receiving induction element supplies the function unit with electrical energy. Furthermore, it is conceivable that the small household appliance has an energy storage device, in particular a rechargeable battery, which is provided so as in a state of charge to store electrical energy that is received via the receiving induction element and in a state of discharge to provide it for supplying the function unit.

A “control unit” is to be understood as an electronic unit that is provided so as to control and/or regulate at least the inverter unit. It is preferred that the control unit comprises a computing unit and, in particular, in addition to the computing unit, a memory unit having stored therein a control and/or a regulating program which is intended to be executed by the computing unit. The control unit is preferably provided so as to interrupt the provision of the supply AC current by the inverter unit in at least one operating state for the first time window in such a manner that at least one inverter switching element of the inverter unit, which supplies at least one supply induction element with supply AC current for providing the supply power to the small household appliance during at least one time window that is different from the first time window, in particular during the second time window and/or a further time window, is not supplied with an input-side rectified mains AC voltage during the first time window. However, it is also conceivable that the control unit is provided so as in the at least one operating state to interrupt the provision of the supply AC current by the inverter unit but to allow a provision by the inverter unit within the first time window of a further AC current which is different from the supply AC current and which differs from the supply AC current in particular by a frequency and/or amplitude and/or phase and whose power is at least 50% less that the supply power. The further AC current that is different from the supply AC current could, for example, be a control current which the inverter unit provides so as to perform object recognition, in particular foreign object recognition, of metal objects that are placed above the supply induction element and/or so as perform a wireless communication by means of inductive signals between the supply induction element and the receiving induction element by the control unit during the first time window. In particular, it is conceivable that the control unit is provided so as to operate at least one further inverter switching element of the inverter unit which is provided for inductively providing power to a further small household appliance during the first time window. The control unit could be provided so as to interrupt the provision of the supply AC current by the inverter unit in temporally irregularly recurring intervals of first time windows, for example during at least three first time windows that are irregularly temporally spaced apart with respect to each other within the control period. It is preferred that the control unit is provided so as to interrupt the provision of the supply AC current by the inverter unit in temporally regularly, in particular periodically, recurring intervals of first time windows, which in particular may correspond to a fraction or a multiple of a period duration of a mains AC voltage.

A “switching parameter set” is to be understood as a set of at least one switching parameter and preferably multiple switching parameters of the inverter unit. In particular, a switching parameter set is at least one switching parameter that is associated with an inverter switching element of the inverter unit. A “switching parameter” is to be understood as a parameter which, during operation of the inverter unit, is directly within the sphere of influence of the control unit and/or can be controlled and/or regulated by it. Alternatively or additionally, the switching parameter can be within the sphere of influence of a user and thus be indirectly or directly controlled and/or selected by a user. The switching parameter can, without being limited thereto, be a switching frequency and/or an amplitude and/or a phase of an AC current, in particular of the AC supply current, which is provided by at least one inverter switching element of the inverter unit for operating the supply induction element. Furthermore, the switching parameter could be a switch-on point in time and/or a switch-off point in time and/or a switch-on duration and/or a switch-off duration of at least one inverter switching element of the inverter unit. Furthermore, the switching parameter could be a parameter which relates to at least two inverter switching elements of the inverter unit which cooperate so as to operate the supply induction element, for example a phase shift between the at least two inverter switching elements. So as to adjust the at least one switching parameter of the switching parameter set in the second time window, the control unit could be provided so as to perform a frequency modulation and/or an amplitude modulation and/or a duty cycle modulation of at least one of the inverter switching elements and/or so as to vary a switch-on point in time and/or a switch-off point in time and/or a switch-on duration and/or a switch-off duration of at least one of the inverter switching elements.

In the present application, numerical words, such as for example “first” and “second”, which precede specific terms, only serve to distinguish objects and/or to assign objects with respect to each other and do not imply an existing total number and/or ranking of objects. In particular, a “second object” does not necessarily imply the presence of a “first object”.

“Provided” is to be understood as specially programmed, laid out and/or equipped. By the fact that an object is intended to perform a specific function, it is to be understood that the object performs and/or executes this specific function in at least one application and/or operating state.

It is further proposed that the first time window comprises a point in time in which a mains AC voltage has a maximum value. Such an embodiment can advantageously further increase flexibility. If the first time window comprises a point in time in which a mains AC voltage has a maximum value, it is possible to further improve adjusting the supply power for the small household appliance. In particular, small household appliances that have a particularly low power requirement can be supplied inductively with energy by the supply unit. Furthermore, it is advantageously possible to improve the adjusting of the supply power of small household appliances that have different power levels that extend over a wide power spectrum, and in particular it is possible to enable continuous power adaptation over the entire power spectrum. It is preferred that the control unit is provided so as to determine the first time window such that it comprises the point in time in which a mains AC voltage has a maximum value.

It is also proposed that a duration of the first time window is at least 1.0 ms. This can advantageously improve operating comfort. In particular, at least one further operation, for example a wireless communication, can be advantageously performed by the control unit within the first time window if its duration is at least 1.0 ms. It is preferred that the control unit is configured so as to determine the duration of the first time window so that it is at least 1.0 ms. Advantageously, the duration of the first time window is at least 1.25 ms, particularly advantageously at least 1.5 ms, preferably at least 1.75 ms, and particularly preferably at least 2.0 ms.

Furthermore, it is proposed that a duration of the first time window is shorter than half a period duration of a mains AC voltage. This can advantageously further improve an adjustment of the supply power for the small household appliance. In particular, it can be ensured that the supply power for the household small appliance is not below a minimum power over the control period if the duration of the first time window is shorter than half a period of a mains AC voltage. It is preferred that the duration of the first time window corresponds maximal to a quarter of the period duration of the mains AC voltage. It is preferred that the control unit is provided so as to set the duration of the first time window such that it is shorter than half a period duration of the mains AC voltage.

Furthermore, it is proposed that the control unit in at least one operating state interrupts a provision of AC current by the inverter unit for at least one further first time window within the control period. Such an embodiment can advantageously render possible a particularly precise adjustment of the supply power for the small household appliance. The control unit could be provided so as to arrange the first time window and the further first time window temporally spaced apart with respect to each other within one or more period durations of a mains AC voltage. In a particularly advantageous embodiment, however, it is proposed that the control unit is provided so as to arrange the first time window and the further first time window temporally spaced apart with respect to each other within half a period of a mains AC voltage. Such an embodiment can advantageously achieve a particularly rapid and precise adjustment of the supply power for the small household appliance, whereby in particular operating comfort can be improved.

A duration of the further first time window could correspond to a duration of the first time window. Moreover, it would be conceivable that a duration of the further first time window is longer than a duration of the first time window. In a particularly advantageous embodiment, however, it is proposed that in at least one operating state a duration of the further first time window is shorter than a duration of the first time window. Advantageously, flexibility can be further increased by this. In particular, a precision in the adjustment of the supply power for the small household appliance can be further improved advantageously. It is preferred that the control unit is provided so as to determine the duration of the further first time window such that it is shorter than the duration of the first time window. The duration of the further first time window is in particular shorter than the duration of the first time window by at least 15%, advantageously by at least 20%, particularly advantageously by at least 25%, preferably by at least 30%, particularly preferably by at least 40% and particularly preferably by at least 50%.

Furthermore, it is proposed that the switching parameter set comprises at least one switching frequency of at least one inverter switching element of the inverter unit. This can advantageously further improve an adjustment of the supply power for the small household appliance. In particular, a particularly simple power adaptation of the supply power can be rendered possible. In addition, it is proposed that the switching parameter set comprises at least one switching parameter that characterizes a switch-on duration of at least one inverter switching element of the inverter unit. This can advantageously further improve an adjustment of the supply power for the small household appliance. It is conceivable that the at least one switching parameter that characterizes the switch-on duration is the switch-on duration of the at least one inverter switching element of the inverter unit. Alternatively or additionally, the at least one switching parameter that characterizes the switch-on duration could comprise a switch-on point in time and a switch-off point in time of the at least one inverter switching element of the inverter unit. Furthermore, it is proposed that the switching parameter set comprises at least one switching parameter of at least one inverter switching element of the inverter unit that characterizes a switch-on point in time. This can advantageously further improve an adjustment of the supply power for the small household appliance. It is conceivable that the at least one switching parameter that characterizes the switch-on point in time is the switch-on point in time of the at least one inverter switching element of the inverter unit. Alternatively or additionally, the at least one switching parameter that characterizes the switch-on point in time could, for example, also comprise a phase shift between a first inverter switching element and a second inverter switching element of the inverter unit, so that the switch-on point in time would be characterized by the phase shift.

It is further proposed that the control unit is provided so as to temporally space apart the first time window and the second time window with respect to each other by at least half a period duration of the mains AC voltage. Such an embodiment can advantageously further improve an adjustment of the supply power for the small household appliance. For example, it would be conceivable for the control unit in at least one operating state to arrange the first time window within a first half period of the mains AC voltage and the second time window temporally in a subsequent second half period. The control unit could be provided so as to temporally space apart the first time window and the second time window with respect to each other by integer multiples of half a period of the mains AC voltage.

It is further proposed that the induction energy transmission system has a communication unit for wireless communication between the control unit and the small household appliance. Such an embodiment can advantageously improve operating comfort. In addition, an adjustment of the supply power for the small household appliance by the control unit can be advantageously improved, for example, in that operating parameters, such as a currently adjusted power level of the small household appliance, can be sent wirelessly from the small household appliance to the control unit by means of the communication unit. It would be conceivable that the communication unit is connected to the supply unit or forms part of the supply unit, wherein the wireless communication could take place by means of inductive communication signals, between the supply induction element and the receiving induction element. It would also be conceivable for the communication unit to have at least one inductive communication element, which is configured separately from the supply induction element and is connected to the control unit. Wireless communication could then take place between the inductive communication element and the receiving induction element or a further inductive communication element of the communication unit, which is arranged in the small household appliance, by means of inductive communication signals. The communication unit could in addition be provided for wireless data transmission between the control unit and the small household appliance by RFID, or by WIFI, or by Bluetooth, or by ZigBee, or for wireless data transmission according to another suitable standard. It is preferred that the communication unit is provided for wireless data transmission between the placement unit and the control unit via NFC. It is preferred that the communication unit is provided for bidirectional wireless data transmission, in other words for both wireless reception and wireless transmission of data. It is preferred that the communication unit has at least one communication element that is connected to the control unit and is provided in particular for wireless reception and transmission of data. It is preferred that the communication unit has at least one further communication element, which is arranged within the small household appliance and is provided in particular for wireless reception and transmission of data.

Furthermore, it is proposed that the control unit is provided so as to perform the wireless communication with the small household appliance by means of the communication unit within the first time window. Advantageously, wireless communication can be improved thereby. Interactions between wireless communication signals and an AC electromagnetic field that is generated by the supply induction element for providing supply power to the small household appliance can be advantageously prevented, whereby interference and transmission errors in the wireless communication can be advantageously reduced, preferably minimized.

The invention further relates to a method for operating an induction energy transmission system, in particular according to one of the previously described embodiments, having a supply unit which has at least one supply induction element for inductively providing energy and at least one inverter unit for operating the supply induction element, having at least one small household appliance which has at least one receiving induction element for receiving the inductively provided energy.

It is proposed that a supply power for the small household appliance is adjusted in that a provision of AC current by the inverter unit is interrupted for at least a first time window within a control period and at least one switching parameter of a switching parameter set of the inverter unit is adjusted in a second time window within the control period. Such a method can advantageously render possible a particularly flexible operation of the induction energy transmission system, in particular with regard to an adjustment of the supply power for the small household appliance.

The induction energy transmission system is not intended here to be limited to the application and embodiment described above. In particular, the induction energy transmission system can have a number of individual elements, components and units different from a number of individual elements, components and units described herein in order to fulfill a mode of operation described herein.

Further advantages result from the following drawing description. The drawing shows embodiments of the invention. The drawing, the description and the claims contain numerous features in combination. The person skilled in the art will expediently also consider the features individually and combine them to form useful further combinations.

In the drawing:

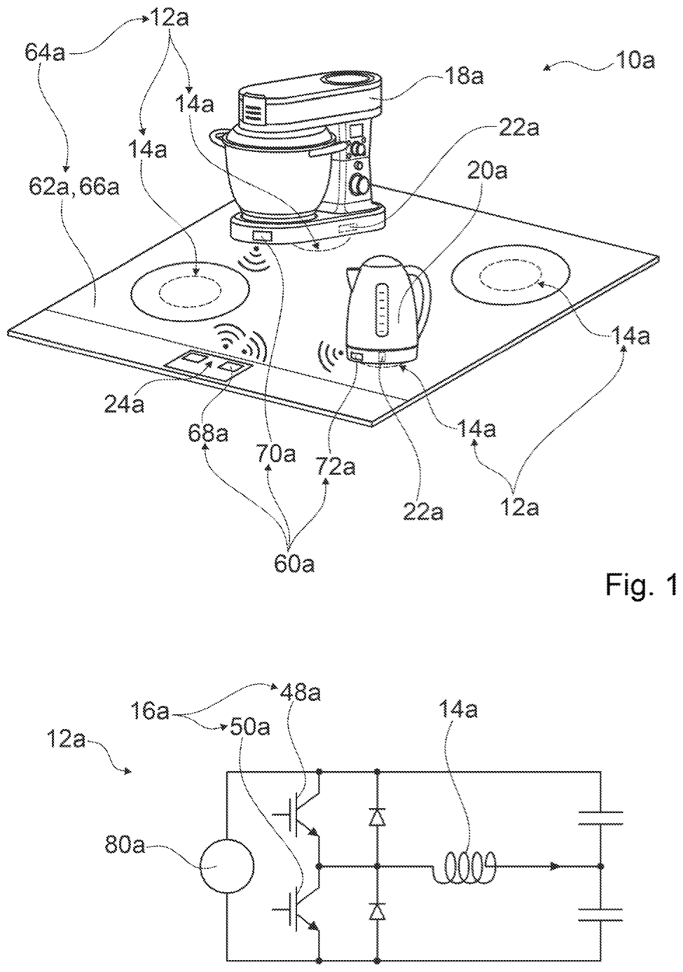

FIG. 1 shows a schematic representation of an induction energy transmission system having a supply unit, a control unit and two small household appliances,

FIG. 2 shows a schematic electrical circuit diagram of a circuit of the supply unit, having an inverter unit for operating a supply induction element of the supply unit,

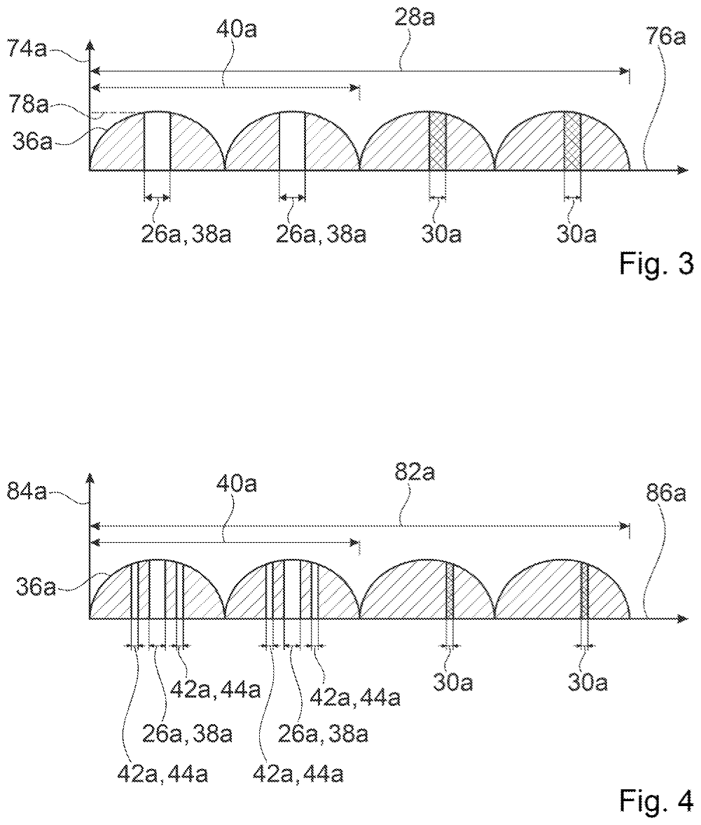

FIG. 3 shows a schematic diagram to illustrate a control of the inverter unit by the control unit within a control period,

FIG. 4 shows a schematic diagram to illustrate a control of the inverter unit by the control unit within a further control period,

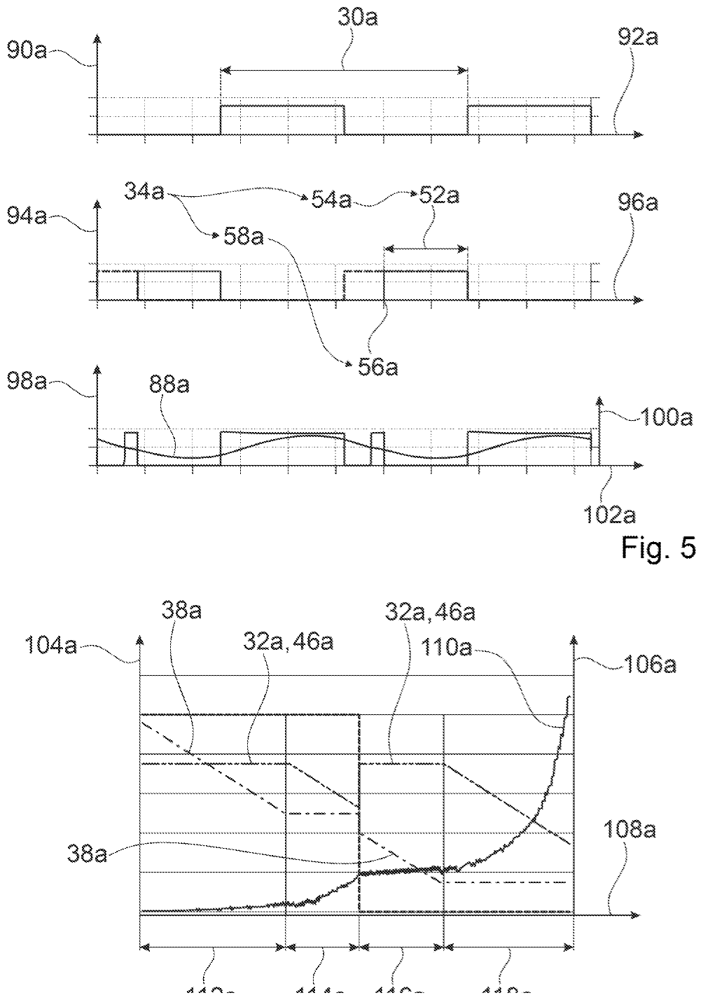

FIG. 5 shows three schematic diagrams to illustrate a switching parameter set of the inverter unit,

FIG. 6 shows a schematic diagram to illustrate a power spectrum of the supply unit,

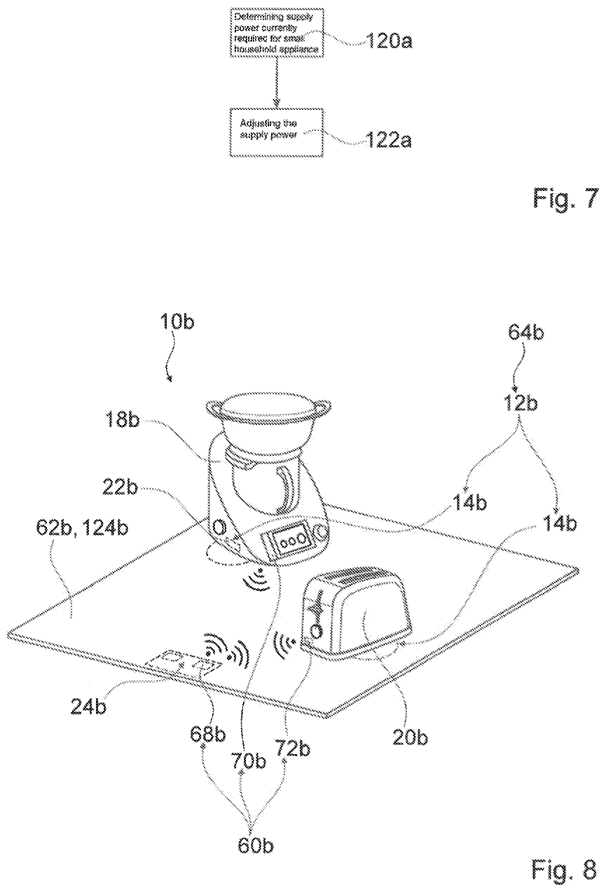

FIG. 7 shows a schematic diagram to illustrate a method for operating the induction energy transmission system, and

FIG. 8 shows a schematic representation of a further embodiment of an induction energy transmission system having a supply unit, a control unit and two small household appliances.

FIG. 1 shows a schematic representation of an induction energy transmission system 10a. The induction energy transmission system 10a has a supply unit 12a. The supply unit 12a has at least one supply induction element 14a for inductively providing energy. In the present case, the supply unit 12a comprises a total of four supply induction elements 14a, although any other number would be conceivable.

The induction energy transmission system 10a has an inverter unit 16a (cf. FIG. 2). The inverter unit 16a is provided so as to operate the supply induction element 14a.

The induction energy transmission system 10a has a placement plate 62a. The supply unit 12a is arranged below the placement plate 62a.

The induction energy transmission system 10a is configured in the present case as an induction cooking system and comprises an induction cooktop 64a. In the present case, the placement plate 62a is configured as a cooktop plate 66a. The cooktop plate 66a and the supply unit 12a are each part of the induction cooktop 64a.

The induction energy transmission system 10a comprises a small household appliance 18a. The small household appliance 18a has a receiving induction element 22a for receiving energy that is inductively provided by the supply unit 12a. In the present case, the small household appliance 18a is configured as a kitchen machine. In the present case, the induction energy transmission system 10a has a further small household appliance 20a. The further small household appliance 20a also comprises a receiving induction element 22a for receiving the energy that is inductively provided by the supply unit 12a. The further small household appliance 20a is configured as a kettle.

The induction energy transmission system 10a has a control unit 24a. The control unit 24a is provided so as to control the inverter unit 16a. The induction energy transmission system 10a has a communication unit 60a. The communication unit 60a is provided for wireless communication between the control unit 24a and the small household appliance 18a. In the present case, the communication unit 60a is also provided for wireless communication between the control unit 24a and the further small household appliance 20a. The communication unit 60a has a communication element 68a which is connected to the control unit 24a and is provided for wireless transmission and reception of data. The communication unit 60a has a further communication element 70a which is arranged in the small household appliance 18a and is provided for wireless transmission and reception of data. Furthermore, the communication unit 60a has a further communication element 72a which is arranged in the further small household appliance 20a and is provided for wireless transmission and reception of data. In the present case, the communication unit 60a is configured as an NFC communication unit and is provided for wireless communication via NFC between the control unit 24a and the small household appliance 18a and/or the further small household appliance 20a.

FIG. 2 shows a schematic electrical circuit diagram of an electrical circuit of the supply unit 12a. The circuit comprises the supply inductor element 14a, and an inverter switching element 48a and a further inverter switching element 50a of the inverter unit 16a. In the present case, the inverter switching elements 48a, 50a are configured as bipolar transistors having an insulated gate electrode (IGBTs) and are arranged in the circuit in a half-bridge circuit. In an operating state, the inverter switching elements 48a, 50a provide a high-frequency supply AC current 88a (cf. FIG. 5) to the supply inductor element 14a for inductively providing energy.

The supply unit 12a has a rectifier 80a which is shown only schematically in FIG. 2. In an operating state, the rectifier 80a rectifies an input-side mains AC voltage 36a, which is provided by a power supply network (not illustrated), into a rectified mains AC voltage 36a (cf. FIG. 3). In the operating state, the inverter switching elements 48a, 50a convert the rectified mains AC voltage 36a into a high-frequency supply AC voltage so as to provide the supply AC current 88a to the supply inductor element 14a.

FIG. 3 shows a schematic diagram to illustrate a control of the inverter unit 16a by the control unit 24a within a control period 28a. Within the control period 28a, based on the control of the inverter unit 16a by the control unit 24a, the supply inductor element 14a provides inductive energy to the receiving inductor element 22a corresponding to a first supply power of the small household appliance 18a at a first power level.

A value of the rectified mains AC voltage 36a is plotted in volts on an ordinate 74a of the graph of FIG. 3. The rectified mains AC voltage 36a is a pulsating DC voltage. A time is plotted in milliseconds on an abscissa 76a of the graph.

In at least one operating state, the control unit 24a interrupts a provision of supply AC current 88a by the inverter unit 16a for at least a first time window 26a within the control period 28a so as to adjust a supply power for the small household appliance 18a and/or for the further small household appliance 20a. In the present case, the control unit 24a interrupts a provision of supply AC current 88a by the inverter unit 16a in each case during a first time window 26a within a first half-wave and within a second half-wave of the mains AC voltage 36a. Each half-wave of the mains AC voltage 36a lasts for exactly half a period duration 40a of the mains AC voltage 36a.

The first time window 26a comprises a point in time in which the mains AC voltage 36a has a maximum value 78a. A duration 38a of the first time window 26a is at least 1.0 ms. The duration 38a of the first time window 26a is shorter than half the period duration 40a of the mains AC voltage 36a. Within the control period 28a, the duration 38a of the first time window 26a is exactly 2.0 ms.

So as to adjust of the supply power for the small household appliance 18a and/or for the further small household appliance 20a, the control unit adapts at least one switching parameter 32a (cf. FIG. 6) of a switching parameter set 34a (cf. FIG. 5) of the inverter unit 16a in at least one operating state in a second time window 30a within the control period 28a.

In the present case, the control unit 24a adapts the switching parameter 32a of the switching parameter set 34a in each case during a second time period 30a within a third half-wave and within a fourth half-wave of the rectified mains AC voltage 36a.

The switching parameter set 34a comprises at least one switching frequency 46a (cf. FIG. 6) of at least one inverter switching element 48a, 50a of the inverter unit 16a. In the present case, the switching parameter 32a is the switching frequency 46a of the inverter switching elements 48a, 50a.

FIG. 4 shows a schematic diagram to illustrate a control of the inverter unit 16a by the control unit 24a within a control period 82a.

Within the control period 82a, based on the control of the inverter unit 16a by the control unit 24a, the supply inductor element 14a provides inductive energy to the receiving inductor element 22a corresponding to a second supply power of the small household appliance 18a in a second power stage.

On an ordinate 86a of the diagram of FIG. 4, a value of the rectified mains AC voltage 36a is plotted in volts. A time is plotted in milliseconds on an abscissa 84a of the diagram.

In at least one operating state, the control unit 24a interrupts a provision of supply AC current 88a by the inverter unit 16a for at least a first time window 26a within the control period 82a so as to adjust a supply power for the small household appliance 18a and/or for the further small household appliance 20a. In the present case, the control unit 24a interrupts a provision of supply AC current 88a by the inverter unit 16a in each case during a first time window 26a within a first half-wave and within a second half-wave of the rectified mains AC voltage 36a. The control unit 24a interrupts a provision of AC current by the inverter unit 16a for at least one further first time window 42a within the control period 82a in at least one, in particular in the, operating state.

The control unit 24a is provided so as to arrange the first time window 26a and the further first time window 42a temporally spaced apart with respect to each other within the half period duration 40a of the mains AC voltage 36a. In the present case, the control unit 24a arranges the first time window 26a and two further first time windows 42a in the control period 82a in each case temporally spaced apart with respect to each other within a first and within a second half-wave of the mains AC voltage 36a. In at least one, in particular in the, operating state, a duration 44a of the further first time window 42a is shorter than a duration 38a of the first time window 26a. Within the further control period 82a, the duration 38a is 1.5 ms in the present case. The duration 44a of the further first time window 42a within the control period 82a is 0.5 ms in the present case.

FIG. 5 shows an overview of three schematic diagrams to illustrate the switching parameter set 34a of the inverter unit 16a. On an ordinate 90a of an upper diagram, a voltage which is applied to the inverter switching element 48a in a closed state is plotted in volts. A time is plotted in milliseconds on an abscissa 92a of the upper diagram.

On an ordinate 94a of a middle diagram of FIG. 5, a voltage which is applied to the further inverter switching element 50a in a closed state is plotted in volts. On an abscissa 96a of the middle diagram a time is plotted in milliseconds.

On a left ordinate 98a of a lower diagram of FIG. 5, a voltage which is applied to the inverter switching element 48a or the further inverter switching element 50a in a closed state is plotted in volts. On a right ordinate 100a of the lower diagram, a current strength of the supply AC current 88a is plotted in amperes. A time is plotted in milliseconds on an abscissa 102a of the lower diagram.

The switching parameter set 34a comprises at least one switching parameter 54a that characterizes a switch-on duration 52a of at least one inverter switching element 48a, 50a of the inverter unit 16a. In the present case, the switching parameter 54a is the switch-on duration 52a of the further inverter switching element 50a within the second time window 30a. The switching parameter set 34a further comprises at least one switching parameter 58a that characterizes a switch-on point in time 56a of at least one inverter switching element 48a, 50a of the inverter unit 16a. In the present case, the switching parameter is the switch-on point in time 56a of the further inverter switching element 50a within the second time window 30a.

FIG. 6 shows a schematic diagram to illustrate a power spectrum of the supply unit 12a. A time is plotted in milliseconds on a left ordinate 104a. On a right ordinate 106a, a power 110a that can be inductively provided by the supply induction element 14a is plotted in watts. On an abscissa 108a of the diagram, the switching frequency 46a of the inverter switching element 48a or of the further inverter switching element 50a is plotted in kilohertz. In the present case, the power spectrum of the power that can be provided by the supply induction element 14a of the supply unit 12a is, for example, between 0 and 2,000 watts. In the present case, the switching frequency 46a of the inverter switching elements 48a, 50a can be controlled by the control unit 24a in a range between 0 and 75 kilohertz.

The diagram of FIG. 6 is divided into four power ranges by way of example. A first power range 112a comprises supply powers between 0 and 200 watts. An adjustment of the supply power by the control unit 24a within the first power range 112a is performed by varying the duration 38a of the first time window 26a (cf. FIGS. 3 and 4). The longer the duration 38a of the first time window 26a, the lower the supply power. A second power range 114a comprises supply powers between 200 and 500 watts. An adjustment of the supply power by the control unit 24a within the second power range 114a is performed by adapting the switching parameter 32a of the switching parameter set 34a, in the present case, for example, by adjusting the switching frequency 46a. In the present case, the control unit 24a operates the inverter unit 16a in a zero voltage switching mode (ZVS mode), so that the supply power increases with decreasing switching frequency 46a. A third power range 116a comprises supply powers between 500 and 600 watts. Adjustment of the supply power by the control unit 24a within the third power range 116a is again performed by varying the duration 38a of the first time window 26a. In contrast to the first power range 112a, the first time window now no longer comprises the point in time of the maximum value 78a of the mains AC voltage 36a (cf. FIG. 3), but a point in time of a minimum value of the mains AC voltage 36a. A fourth power range 118a comprises supply powers between 600 and 2,000 watts. An adjustment of the supply power by the control unit 24a within the fourth power range 118a is again performed by adapting the switching parameter 32a of the switching parameter set 34a, in the present case, for example, by further reducing the switching frequency 46a.

FIG. 7 shows a schematic diagram to illustrate a method for operating the induction energy transmission system 10a. In the method, the supply power for the small household appliance 18a is adjusted in that a provision of AC current by the inverter unit 16a is interrupted for at least the first time window 26a within the control period 28a and at least one switching parameter 32a, 54a, 58a of the switching parameter set 34a of the inverter unit 16a is adjusted in the second time window 30a within the control period 28a. The method comprises at least two method steps. In a first method step 120a of the method, a supply power that is currently required for the small household appliance 18a is determined. For example, the supply power currently required by the small household appliance 18a could be automatically transmitted to the control unit 24a by means of the communication unit 60a in the first method step 120a. In a second method step 122a of the method, the supply power for the small household appliance 18a is adjusted in that a provision of AC current by the inverter unit 16a is interrupted for at least the first time window 26a within the control period 28a and at least one switching parameter 32a, 54a, 58a of the switching parameter set 34a of the inverter unit 16a is adapted in the second time window 30a within the control period 28a.

FIG. 8 shows a further embodiment of the invention. The following descriptions are essentially limited to the differences between the exemplary embodiments, wherein reference can be made to the description of the exemplary embodiment of FIGS. 1 to 7 with regard to components, features and functions which remain the same. In order to distinguish between the embodiments, the letter a in the reference characters of the exemplary embodiment in FIGS. 1 to 7 is replaced by the letter b in the reference characters of the exemplary embodiment in FIG. 8. With regard to components with the same designation, in particular with regard to components with the same reference characters, reference can, in principle, also be made to the drawings and/or the description of the exemplary embodiment of FIGS. 1 to 7.

FIG. 8 shows a schematic representation of an induction energy transmission system 10b. The induction energy transmission system 10b has a supply unit 12b having at least one supply induction element 14b for inductively providing energy. In the present case, the supply unit 12b comprises a total of two supply induction elements 14b, although any other number would be conceivable.

The induction energy transmission system 10b has an inverter unit (not shown) for operating the supply induction element 14a.

The induction energy transmission system 10b has a set-up plate 62b. The supply unit 12b is disposed below the set-up plate 62b.

In the present case, the induction energy transmission system 10b is configured as an induction cooking system and comprises an induction cooktop 64b. In contrast to the previous exemplary embodiment, the induction cooktop 64b is configured as an invisible induction cooktop 64b. The supply unit 12b is part of the induction cooktop 64b. In contrast to the preceding exemplary embodiment, the placement plate 62b of the induction energy transmission system 10b is configured as a kitchen worktop 124b.

The induction energy transmission system 10b includes a small household appliance 18b. The small household appliance 18b has a receiving induction element 22b for receiving energy that is inductively provided by the supply unit 12b. In the present case, the small household appliance 18b is configured as a kitchen machine. In the present case, the induction energy transmission system 10b has a further small household appliance 20b. The further small household appliance 20b also comprises a receiving induction element (not shown) for receiving the energy that is inductively provided by the supply unit 12b. The further small household appliance 20b is configured as a toaster.

The induction energy transmission system 10b has a control unit 24b. The control unit 24b is provided so as to control the inverter unit of the power supply unit 12b.

The induction energy transmission system 10b has a communication unit 60b for wireless communication between the control unit 24b and the small household appliance 18b and/or the further small household appliance 20b. The communication unit 60b has a

communication element 68b that is connected to the control unit 24b, and two further communication elements 70b, 72b that are arranged in the small household appliance 18a and in the further small household appliance 20b, respectively. In the present case, the communication unit 60b is configured as an NFC communication unit, and is provided for wireless communication via NFC between the control unit 24b and the small household appliance 18b and/or the further small household appliance 20b.

In at least one operating state, the control unit 24b interrupts a provision of supply AC current by the inverter unit for at least a first time window within a control period so as to adjust a supply power for the small household appliance 18b and/or the further small household appliance 20b. Furthermore, the control unit adjusts at least one switching parameter of a switching parameter set of the inverter unit so as to adapt the supply power for the small household appliance 18b and/or the further small household appliance 20b in at least one operating state in a second time window within the control period. With regard to the basic operating principle of the adjustment of the supply power by the control unit 24b, reference can be made to the above description of the preceding exemplary embodiment of FIGS. 1 to 7.

### REFERENCE CHARACTERS

10 Induction energy transmission system
12 Supply unit
14 Supply induction element
16 Inverter unit
18 Small household appliance
20 Further small household appliance
22 Receiving induction element
24 Control unit
26 First time window
28 Control period
30 Second time window
32 Switching parameter
34 Switching parameter set
36 Mains AC voltage
38 Duration
40 Period duration
42 Further first time window
44 Duration
46 Switching frequency
48 Inverter switching element
50 Further inverter switching element
52 Switch-on duration
54 Switching parameter
56 Switch-on point in time
58 Switching parameter
60 Communication unit
62 Placement plate
64 Induction cooktop
66 Cooktop plate
68 Communication element
70 Further communication element
72 Further communication element
74 Ordinate
76 Abscissa
78 Maximum value
80 Rectifier
82 Control period
84 Abscissa
86 Ordinate
88 Supply AC current
90 Ordinate
92 Abscissa
94 Ordinate
96 Abscissa
98 Left ordinate
100 Right ordinate
102 Abscissa
104 Left ordinate
106 Right ordinate
108 Abscissa
110 Power
112 First power range
114 Second power range
116 Third power range
118 Fourth power range
120 First method step
122 Second method step
124 Kitchen worktop

1-14. (canceled)

15. An induction energy transmission system, comprising:
a supply unit including a supply induction element designed to inductively provide energy and an inverter unit designed to operate the supply induction element;
a small household appliance including a receiving induction element designed to receive inductively provided energy; and
a control unit designed to control the inverter unit, said control unit being designed such as to interrupt in at least one operating state for adjusting a supply power for the small household appliance a provision of supply AC current by the inverter unit for a first time window within a control period and to adapt in a second time window within the control period at least one switching parameter of a switching parameter set of the inverter unit.

16. The induction energy transmission system of claim 15, constructed in a form of an induction cooking system.

17. The induction energy transmission system of claim 15, wherein the first time window comprises a point in time in which a mains AC voltage has a maximum value.

18. The induction energy transmission system of claim 15, wherein a duration of the first time window is at least 1.0 ms.

19. The induction energy transmission system of claim 15, wherein a duration of the first time window is shorter than half a period duration of a mains AC voltage.

20. The induction energy transmission system of claim 15, wherein the control unit is designed to interrupt in at least one operating state the provision of supply AC current by the inverter unit for at least a further first time window within a control period.

21. The induction energy transmission system of claim 20, wherein the control unit is designed to arrange the first time window and the further first time window temporally spaced apart with respect to each other within half a period duration of a mains AC voltage.

22. The induction energy transmission system of claim 20, wherein in at least one operating state a duration of the further first time window is shorter than a duration of the first time window.

23. The induction energy transmission system of claim 15, wherein the inverter unit comprises an inverter switching element, the switching parameter set comprising a switching frequency of the inverter switching element of the inverter unit.

24. The induction energy transmission system of claim 15, wherein the inverter unit comprises an inverter switching element, the switching parameter set comprising a switching parameter of the inverter switching element of the inverter unit, with the switching parameter characterizing a switch-on duration.

25. The induction energy transmission system of claim 15, wherein the inverter unit comprises an inverter switching element, the switching parameter set comprising a switching parameter of the inverter switching element of the inverter unit, with the switching parameter characterizing a switch-on point in time.

26. The induction energy transmission system of claim 15, wherein the control unit is designed to temporally space apart the first time window and the second time window with respect to each other by at least half a period duration of the mains AC voltage.

27. The induction energy transmission system of claim 15, further comprising a communication unit designed to provide a wireless communication between the control unit and the small household appliance.

28. The induction energy transmission system of claim 27, wherein the control unit is designed to perform the wireless communication with the small household appliance via the communication unit within the first time window.

29. A method for operating an induction energy transmission system, the method comprising:
operating a supply induction element of an inverter unit for inductively providing energy to a receiving induction element of a small household appliance; and
adjusting a supply power for the small household appliance by interrupting a provision of AC current by the inverter unit for a first time window within a control period and by adapting in a second time window within the control period a switching parameter of a switching parameter set of the inverter unit.

30. The method of claim 29, wherein a duration of the first time window is at least 1.0 ms.

31. The method of claim 29, wherein a duration of the first time window is shorter than half a period duration of a mains AC voltage

32. The method of claim 29, further comprising interrupting in at least one operating state the provision of supply AC current by the inverter unit for at least a further first time window within a control period.

33. The method of claim 32, further comprising arranging the first time window and the further first time window temporally spaced apart with respect to each other within half a period duration of a mains AC voltage.

34. The method of claim 32, wherein in at least one operating state a duration of the further first time window is shorter than a duration of the first time window.
